(19) United States
(12) Patent Application Publication
(10) Pub. No.: US 2012/0181380 A1
(43) Pub. Date: Jul. 19, 2012

(54) SYSTEM FOR PROVIDING A RAPIDLY ELEVATED AEROSTAT PLATFORM

(76) Inventors: Peter K. Van Staagen, Madison, AL (US); William Douglas McDaniel, Huntsville, AL (US); James H. Boschma, JR., Huntsville, AL (US)

(21) Appl. No.: 13/009,207

(22) Filed: Jan. 19, 2011

(51) Int. Cl. B64B 1/50; B64B 1/40

(52) U.S. Cl. 244/33; 244/31

(57) ABSTRACT

A system and method for deploying a payload with an aerostat uses a mobile transporter for moving the system to a deployment site. Structurally, the system includes a base unit with a rotation head mounted thereon. An envelope container for holding a deflated aerostat is mounted on the rotation head and a rotation of the container on the rotation head positions the aerostat for optimal compliance with the existing wind condition. Also included in the system is an inflator that is mounted on the base unit to inflate the aerostat with a Helium gas. And, the system includes a tether control unit for maintaining a connection with the aerostat during its deployment, in-flight use, and recovery. Preferably, a deployment computer is used for a coordinated control of the rotation head, inflator and tether.

### FIELD OF THE INVENTION

The present invention pertains generally to systems and methods for deploying aerostats. More particularly, the present invention pertains to systems and methods for using mobile transporters to selectively position deflated aerostats for rapid operational deployment of the aerostat. The present invention is particularly, but not exclusively, useful as a system and method for use in elevating a substantial payload to a considerable height for operational use at a remote site within a short period of time.

### BACKGROUND OF THE INVENTION

Surveillance of various types and kinds of activities within an extended area of operation can be extremely helpful in many situations. More specifically, the efficacy of the systems and methods used for this surveillance are enhanced when they are mobile and can be rapidly deployed at selected sites. In addition to the need for effective system functionality, other objectives for the deployment of a mobile system involve both the transport of the system to an operational site, and the installation of the system at the site. Of particular interest here is the installation of a surveillance system at an operational site.

It has long been recognized that an elevated observation platform may be preferable in many surveillance situations. And, in many of these situations it is quite acceptable for the elevated observation platform to remain substantially stationary. Accordingly, the use of an aerostat as a payload platform presents considerable possibilities. Depending on the size and weight of the required payload, however, the aerostat that is required to lift the payload may need to be of significant size. The consequence of this is that efforts for the installation of an aerostat deployment site, and the actual deployment of the aerostat at the site need to be carefully coordinated.

In addition to the sheer bulk of the aerostat (particularly when it is inflated), the installation and operation of an aerostat observation site involves several related tasks. These include: inflation of the aerostat with a lighter-than-air gas (e.g. Helium) and position control of the aerostat for compliance with existing wind conditions during its inflation. Further, there is the task of maintaining the necessary physical connections with the aerostat during its deployment, during its in-flight use, and during a recovery of the aerostat. Within this scenario, an inflation of the aerostat is preferably accomplished as disclosed and claimed in U.S. Pat. No. 7,503,277 for an invention entitled “Aerostat Inflator” which is assigned to the same assignee as the present invention. As noted above, however, inflation is but one of the several tasks that must be effectively accomplished, in concert, to achieve an effective methodology for deploying a rapidly elevated aerostat platform.

In light of the above, it is an object of the present invention to provide a system and method for rapidly deploying a payload on an aerostat. Another object of the present invention is to provide a system and method with concerted control components for the inflation, deployment (launch), operational use, and recovery of an aerostat. Still another object of the present invention is to provide a system and method for launching an aerostat, wherein the inflation and deployment of the aerostat to a predetermined altitude can be accomplished very rapidly. Another object of the present invention is to provide a system and method for rapidly deploying a payload on an elevated aerostat platform that is easy to use, is simple to manufacture and is comparatively cost effective.

### SUMMARY OF THE INVENTION

In accordance with the present invention, a system and method for rapidly deploying a payload on an aerostat platform includes individual components that respectively inflate the aerostat, stabilize the aerostat during its inflation, and maintain a physical connection with the aerostat after its inflation. Importantly, the disparate operations of these various components are controlled, in concert with each other, to ensure a rapid inflation and elevation of the aerostat. As envisioned for the present invention, the system is mobile and can be installed at remote sites for quick and efficient surveillance operations.

Structurally, the system of the present invention includes a base unit with a rotation head mounted on the base unit. When mounted, the rotation head is intended to rotate around a substantially vertical axis. An envelope container for holding a deflated aerostat is mounted on the rotation head. With this combination, the envelope container can be rotated on the base unit with the rotation head to position the aerostat for optimal compliance with an existing wind condition. This is particularly important during a deployment of the aerostat. For the present invention, rotation of the envelope container for deployment of the aerostat can be either manually or computer controlled.

A source of a lighter-than air gas (e.g. Helium) is carried on the base unit and is connected in fluid communication with the aerostat. Additionally, an inflator is mounted on the base unit and is connected in fluid communication with the source of lighter-than-air gas. With this connection, the inflator is used to control the transfer of the lighter-than-air gas to the aerostat during an inflation of the aerostat. The consequence here is that the deployment of the aerostat from the container can be controlled as the aerostat is being inflated.

As the aerostat is being inflated and deployed from the envelope container, a tether that is affixed to the aerostat is also deployed. More specifically, a tether control unit is mounted on the base unit and it is connected to the tether. Thus, a connection between the aerostat and the base unit is maintained during operation of the aerostat. Specifically, this connection is maintained during a deployment, an in-flight use, and a recovery of the aerostat. In detail, the tether control unit comprises a spool for storing the tether and a winch that will move the spool to establish an operational tension on the tether while the tether is operationally deployed. Further, the system comprises a deployment computer for coordinating respective operations of the inflator, the rotation head, and the tether control unit. For system flexibility, and as a safety measure, the deployment computer is subject to a manual override that can disconnect the deployment computer from operational control of the aerostat.

As an alternate embodiment of the system for the present invention, a transporter can be provided to enhance the system's mobility. If a transporter is used, the base unit can be fixedly mounted on the transporter. As envisioned for the present invention, if used, the transporter can be a wheeled vehicle, a tracked vehicle, or a trailer. As another additional component, the system may include a mooring unit. Specifically, such a unit would include a mooring mast that can be fixedly mounted on the base unit to extend the mast in a substantially vertical direction from the base unit. The mooring unit will also include a docking ring that is attached to the extended end of the mooring mast for selectively holding an inflated aerostat on the mooring mast when it is in a non-operational mode.

In operation, an example of the capability of the aerostat system, with a 2600 cubic feet in volume aerostat, is that a payload of at least thirty-five pounds can be elevated to a height greater than five hundred feet above ground level. Importantly, this is done in less than ten minutes after commencement of an inflation of a deflated aerostat. Also, by way of example, an aerostat with a volume of 5300 cubic feet, as envisioned for the present invention, can be deployed in less than seven minutes and will easily lift an eighty-five pound payload to a height of 1000 feet.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a side elevation view of a system for providing a rapidly elevated aerostat platform in accordance with the present invention;

FIG. 2 is a view of the system with a deployed aerostat; and

FIG. 3 is a view of the system with an aerostat docked to its mooring mast.

### DESCRIPTION OF THE PREFERRED EMBODIMENTS

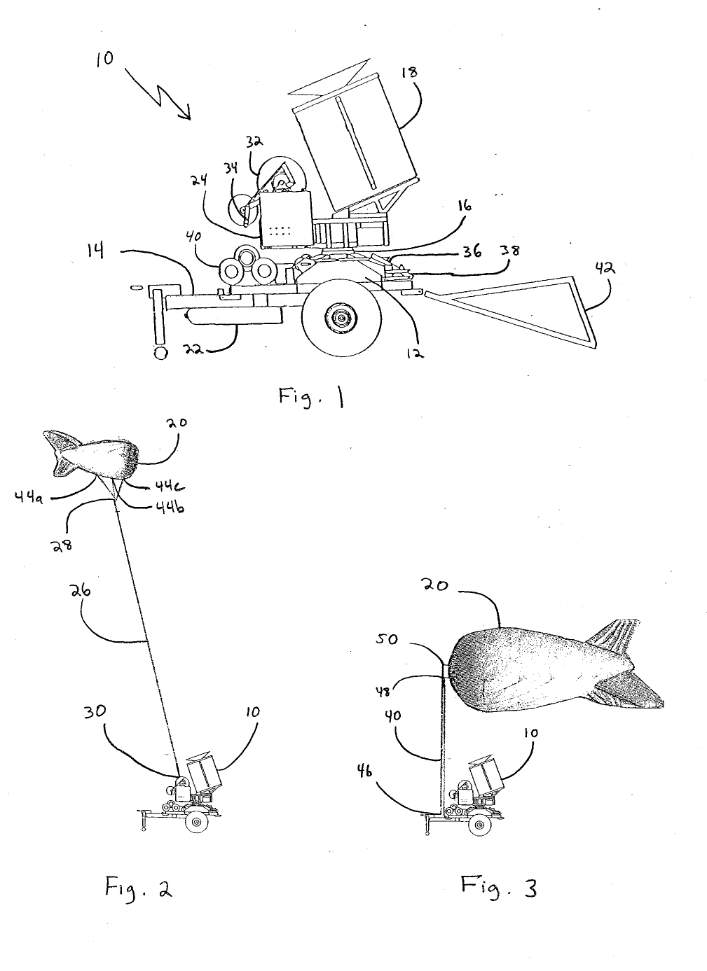

Referring initially to FIG. 1, a system for providing a rapidly elevated aerostat platform is shown and is generally designated 10. As shown, the system 10 includes a base unit 12 affixed to a transporter 14. In this case, the transporter 14 shown in FIG. 1 is a trailer. As will be appreciated, however, the transporter 14 can also be a wheeled vehicle, a tracked vehicle, or any other form of conveyance known in the art. As shown, a rotation head 16 is attached to the base unit 12. Furthermore, an envelope container 18 for holding a deflated aerostat 20 (See FIG. 2 and FIG. 3) is also mounted on the rotation head 16. In addition to the aforementioned components, a gas source 22 is attached to the underside of the transporter 14 and is connected in fluid communication with the aerostat 20. In the embodiment of the present invention shown in FIG. 1, the gas source 22 is preferably a plurality of Helium-filled tanks. As will be appreciated by the skilled artisan, the gas source 22 may be positioned in any location on the transporter 14 where it can be connected in fluid communication with the aerostat 20.

Along with the envelope container 18, a tether control unit 24 is mounted on the rotation head 16. In detail, the tether control unit 24 is comprised of a tether 26, a tether spool 32, and a winch 34. When the aerostat 20 is deployed as shown in FIG. 2, the tether 26 is connected to the aerostat 20 at a first end 28 and to the tether control unit 24 at a second end 30. In order to connect the tether 26 to the aerostat 20, one or more connectors 44a-c is used. The connection of the first end 28 of the tether 26 to the connectors 44a-c can occur prior to the aerostat 20 being packed into the envelope container 18 or as the aerostat 20 emerges from the envelope container 18.

Referring again to FIG. 1, a deployment computer 36 and a manual override 38 are provided and connected to the base unit 12. The deployment computer 36 is used to coordinate the operations of the system 10. Furthermore, the deployment computer 36 may be located in alternate locations. As an example, the deployment computer 36 can be located at a control center that is not located with the system 10. As another example, the deployment computer 36 can be located in the cab of the transporter 14. Moreover, the manual override 38 is used to disconnect the deployment computer 36 and allow for manual control of the system 10. In addition to these components, a reloading jib 42 is connected to the transporter 14 and is used to assist in packing the aerostat 20 into the envelope container 18 after a deployment.

Referring to FIG. 2, the system 10 is shown with an aerostat 20 in its deployed position. Prior to deployment, the deployment computer 36 positions the rotation head 16 according to current wind conditions. In order to commence deployment of the aerostat 20, the deployment computer 36 initiates the inflation of the aerostat 20. Preferably, an inflator as disclosed in U.S. Pat. No. 7,503,277 “Aerostat Inflator” would be used to commence the inflation of the aerostat 20. When the deployment computer 36 initiates the inflation of the aerostat 20, the gas source 22 begins to transfer Helium into the aerostat 20. As it begins to become inflated, the aerostat 20 gradually emerges from the envelope container 18. While inflation is occurring, the deployment computer 36 activates the tether control unit 24, and the tether 26 begins to unwind from the tether spool 32. Either prior to deployment or as the aerostat 20 begins to emerge from the envelope container 18, the first end 28 of the tether 26 is engaged with a series of connectors 44a-c. Once the aerostat 20 is completely inflated and reaches its deployment height, the second end 30 of the tether 26 remains attached to the tether spool 32 to anchor the aerostat 20 to the system 10.

Now referring to FIG. 3, the system 10 is shown with the aerostat 20 secured to a mooring mast 40 connected to the base unit 12. When not in use, the mooring mast 40 remains in a stored position as shown in FIG. 1. When in use, the mooring mast 40 extends to connect to the inflated aerostat 20 as illustrated in FIG. 3. Instead of deflating the aerostat 20 and packing it back into the envelope container 18, the use of the mooring mast 40 allows the aerostat 20 to remain inflated and to deploy again in a more expedient fashion. In this configuration, the first end 46 of the mooring mast 40 is secured to the base unit 12 while the second end 48 of the mooring mast 40 is secured to the aerostat 20. In order to facilitate attachment of the aerostat to the second end 48 of the mooring mast 40, a docking ring 50 is utilized.

While the particular System for Providing a Rapidly Elevated Aerostat Platform as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A system for deploying a payload on an aerostat which comprises:
a base unit;
a rotation head mounted on the base unit for rotation of the rotation head around a substantially vertical axis;
an envelope container for holding a deflated aerostat therein, wherein the envelope container is mounted on the rotation head for rotation therewith to position the aerostat for optimal compliance with an existing wind condition during deployment of the aerostat;
a source of a lighter-than-air gas connected in fluid communication with the aerostat; and
an inflator mounted on the base unit and connected in fluid communication with the source of lighter-than-air gas for controlling the transfer of the lighter-than-air gas to the aerostat to inflate the aerostat for deployment from the container.

2. A system as recited in claim 1 further comprising:
a tether having a first end and a second end, with the first end having at least one connector affixed to the aerostat; and
a tether control unit mounted on the base unit and connected to the second end of the tether for maintaining a connection between the aerostat and the base unit during a deployment, an in-flight use, and a recovery of the aerostat.

3. A system as recited in claim 2 wherein the tether control unit comprises:
a spool for storing the tether; and
a winch for moving the spool to establish an operational tension on the tether.

4. A system as recited in claim 2 further comprising a deployment computer for coordinating respective operations of the inflator, the rotation head and the tether control unit.

5. A system as recited in claim 4 further comprising a manual override to disconnect the deployment computer from operational control.

6. A system as recited in claim 1 wherein the lighter-than-air gas is Helium.

7. A system as recited in claim 1 further comprising a transporter, wherein the base unit is mounted on the transporter and the transporter is selected from a group comprising a wheeled vehicle, a tracked vehicle and a trailer.

8. A system as recited in claim 1 further comprising:
a mooring mast having a first end and a second end, wherein the first end is fixedly mounted on the base unit to extend the mast in a substantially vertical direction from the base unit; and
a docking ring attached to the second end of the mooring mast for selectively holding the aerostat on the mooring mast.

9. A system as recited in claim 1 further comprising a reloading jib for use in packing the aerostat in the envelope container after a deployment of the aerostat.

10. An aerostat system for deploying a payload of at least thirty-five pounds to a height greater than five hundred feet above ground level in less than ten minutes after commencement of an inflation of a deflated aerostat, the system comprising:
a means for rapidly inflating the aerostat with a lighter-than-air gas;
a means for positioning the aerostat for optimal compliance with an existing wind condition during inflation of the aerostat;
a means for maintaining a connection with the aerostat for control thereof during a deployment, an in-flight use, and a recovery of the aerostat; and
a means for coordinating control of the inflating means, the positioning means and the maintaining means.

11. A system as recited in claim 10 wherein the inflating means comprises:
a source of a lighter-than-air gas connected in fluid communication with the aerostat; and
an inflator connected in fluid communication with the source of lighter-than-air gas for controlling the transfer of the lighter-than-air gas to the aerostat to inflate the aerostat for deployment from the container.

12. A system as recited in claim 10 wherein the positioning means comprises:
a rotation head for rotation around a substantially vertical axis; and
an envelope container for holding a deflated aerostat therein, wherein the envelope container is mounted on the rotation head for rotation therewith to position the aerostat for optimal compliance with an existing wind condition during deployment of the aerostat.

13. A system as recited in claim 10 wherein the maintaining means comprises:
a tether having a first end and a second end, with the first end having at least one connector affixed to the aerostat; and
a tether control unit mounted on the base unit and connected to the second end of the tether for maintaining a physical connection between the aerostat and the base unit.

14. A system as recited in claim 13 wherein the tether control unit comprises:
a spool for storing the tether; and
a winch for moving the spool to establish an operational tension on the tether.

15. A system as recited in claim 10 wherein the control coordinating means is a deployment computer.

16. A system as recited in claim 10 wherein the lighter-than-air gas is Helium.

17. A system as recited in claim 10 further comprising a transporter for moving the system, wherein the transporter is selected from a group comprising a wheeled vehicle, a tracked vehicle and a trailer.

18. A system as recited in claim 10 further comprising:
a mooring mast having a first end and a second end, wherein the first end is fixedly positioned to extend in a substantially vertical direction; and
a docking ring attached to the second end of the mooring mast for selectively holding the aerostat on the mooring mast.

19. A method for deploying a payload of at least thirty-five pounds to a height greater than five hundred feet above ground level in less than ten minutes after commencement of an inflation of a deflated aerostat, the method comprising the steps of:
rapidly inflating the aerostat from a source of a lighter-than-air gas using an inflator connected in fluid communication with the source of lighter-than-air gas for controlling the transfer of the lighter-than-air gas to the aerostat to inflate the aerostat for deployment from an envelope container;
positioning the aerostat using a rotation head established for rotation around a substantially vertical axis, wherein the envelope container is mounted on the rotation head for rotation therewith to position the aerostat for optimal compliance with an existing wind condition during inflation and deployment of the aerostat;
maintaining a physical connection with the aerostat for control thereof during a deployment, an in-flight use, and a recovery of the aerostat, using a tether having a first end and a second end, with the first end having at least one connector affixed to the aerostat; and a tether control unit connected to the second end of the tether for maintaining the connection; and
coordinating control of the inflating, the positioning, and the maintaining steps using a deployment computer.

20. A method as recited in claim 19 wherein the lighter-than-air gas is Helium.
